(19) United States
(12) Patent Application Publication
(10) Pub. No.: US 2026/0104020 A1
(43) Pub. Date: Apr. 16, 2026

(54) EVAPORATIVE EMISSIONS CANISTER WITH NON-ADSORBENT, LOW FLOW-RESTRICTION ZONE

(71) Applicant: PHINIA JERSEY HOLDINGS LLC, Wilmington, DE (US)

(72) Inventors: Flavio Ono, Ciudad Juarez (MX); Jonathan Rosalio Martinez Flores, Ciudad Juarez (MX)

(21) Appl. No.: 18/912,879

(22) Filed: Oct. 11, 2024

(51) Int. Cl. F02M 25/08; B01D 53/04; B01J 20/20; B01J 20/28; B01J 20/34

(52) U.S. Cl. CPC F02M 25/0854; B01D 53/0415; B01J 20/20; B01J 20/28016; B01J 20/3416; B01J 20/3458; B01D 2253/102; B01D 2259/40086; B01D 2259/4516; B01D 2259/4566

(57) ABSTRACT

An evaporative emissions canister is provided. The canister includes a casing defining an internal volume therein. The casing includes an inlet and an outlet in fluid communication with the internal volume. The internal volume includes a chamber adjacent to the inlet and the outlet. A first layer of adsorbent material is disposed within the chamber. A layer of non-adsorbent material is disposed adjacent to the first layer of adsorbent material. The non-adsorbent material is one or a combination of an open cell foam, non-adsorbent particles having a Sauter mean diameter (SMD) of greater than 2 mm, and air. The layer of non-adsorbent material may be disposed directly between the first layer of adsorbent material and one or both of the inlet and outlet. The layer of non-adsorbent material has a flow restriction that is less than a flow restriction of the first layer of adsorbent material.

### FIELD OF THE INVENTION

The disclosure generally relates to evaporative emissions canisters for adsorption of fuel vapors generated in fuel storage tanks of fuel-powered vehicles.

### BACKGROUND OF THE INVENTION

Evaporative loss of fuel vapor generated within fuel tanks of the fuel systems of motor vehicles powered by internal combustion engines is a potential contributor to atmospheric air pollution by hydrocarbons. Canister systems that employ activated carbon to adsorb the fuel vapor emitted from the fuel systems are used to limit such evaporative emissions from the fuel tanks of gasoline-fueled automotive vehicles. A typical evaporative emissions canister includes a casing inside of which a gas passage is formed and filled with activated carbon as a fuel vapor adsorbent. Charge and purge ports for fuel vapor are communicated with one end of the gas passage, while an atmospheric port (vent port) for fuel vapor is communicated with the other end of the gas passage, thus allowing for charging of the canister. During stoppage of the vehicle (e.g., when parked), fuel vapor generated from the fuel in the fuel tank is introduced through the charge port into the canister and adsorbed by the adsorbent. During operation of the engine, atmospheric air is introduced through the atmospheric vent port to purge the fuel vapor in the canister by desorbing fuel vapor that was adsorbed in the adsorbent. The flow of air carries the purged fuel vapor to an intake system of the engine through the purge port so that the fuel vapor can be combusted within the engine, thus accomplishing a purging of the canister. By the desorption of fuel vapor during purging, the carbon adsorbent is regenerated and a fuel vapor adsorbing performance of the canister is revived, thereby allowing the adsorbent to repeatedly adsorb fuel vapor during periods of non-use of the engine.

Conventional evaporative emissions canisters commonly use a carbon adsorbent to fill one or more chambers of the canister casing. However, conventional evaporative emissions canisters can suffer from poor or highly restricted air flow through parts of the canister casing, decreasing the amount of fuel vapor that is adsorbed within the canister and potentially leading to an increase in undesired bleed emissions of fuel vapors to the external atmosphere. Therefore, a continued need exists for improved vapor flow within the canister casing.

### BRIEF SUMMARY

An improved evaporative emissions canister is provided. The evaporative emissions canister includes a casing defining an internal volume therein. The casing includes an inlet and an outlet in fluid communication with the internal volume. The internal volume includes a chamber adjacent to the inlet and the outlet. A bed of adsorbent material is disposed within the chamber. The canister further includes a non-adsorbent zone within the chamber. The non-adsorbent zone is disposed directly between the layer of adsorbent material and one or both of the inlet and the outlet. The non-adsorbent zone is one of: i) an open cell foam; ii) a bed of non-adsorbent material; iii) a void space; and iv) any combination of i) through iii).

In specific embodiments, the non-adsorbent zone has a height of at least 10 mm.

In specific embodiments, the open cell foam is formed of a polyurethane (PU) material or a polyether (PE) material.

In particular embodiments, the open cell foam has a thickness of at least 10 mm.

In specific embodiments, the non-adsorbent material has a Sauter mean diameter (SMD) of greater than 2 mm.

In specific embodiments, the void space is filled with air.

In specific embodiments, the adsorbent material has a Sauter mean diameter (SMD) of less than 2 mm.

In specific embodiments, the adsorbent material is an activated carbon that is one of a granular carbon and a pellet carbon.

In specific embodiments, the non-adsorbent zone has a flow restriction that is less than a flow restriction of the bed of adsorbent material.

In other embodiments of the disclosure, the evaporative emissions canister includes a casing defining an internal volume therein. The casing includes an inlet and an outlet in fluid communication with the internal volume. The internal volume includes a chamber adjacent to the inlet and the outlet. A first layer of adsorbent material is disposed within the chamber. A layer of non-adsorbent material is disposed adjacent to the first layer of adsorbent material. The non-adsorbent material is one of: i) an open cell foam; ii) non-adsorbent particles; iii) air; and iv) any combination of i) through iii).

In specific embodiments, the open cell foam is formed of a polyurethane (PU) material or a polyether (PE) material.

In specific embodiments, the non-adsorbent particles have a Sauter mean diameter (SMD) of greater than 2 mm.

In specific embodiments, the adsorbent material is an activated carbon that is one of a granular carbon and a pellet carbon.

In specific embodiments, the layer of non-adsorbent material is disposed directly between the first layer of adsorbent material and one or both of the inlet and the outlet.

In specific embodiments, the layer of non-adsorbent material has a flow restriction that is less than a flow restriction of the first layer of adsorbent material.

In specific embodiments, the canister further includes a second layer of adsorbent material within the chamber, and the layer of non-adsorbent material is sandwiched between the first layer of adsorbent material and the second layer of adsorbent material.

In particular embodiments, the second layer of adsorbent material has a flow restriction that is less than a flow restriction of the first layer of adsorbent material, and the layer of non-adsorbent material has a flow restriction that is lower than the flow restriction of the first layer of adsorbent material.

In certain embodiments, the second layer of adsorbent material is closer to the inlet and outlet than the first layer of adsorbent material.

In particular embodiments, the adsorbent material forming the first layer is an activated carbon that is one of a granular carbon and a pellet carbon, and the adsorbent material forming the second layer is one of a granular carbon and a pellet carbon.

In certain embodiments, the adsorbent material forming the second layer is a pellet carbon having a low flow restriction, and the adsorbent material forming the first layer is a granular carbon having a high flow restriction.

In specific embodiments, the chamber includes a first portion having a first cross-sectional area, the first portion being adjacent the inlet and outlet of the casing. The chamber further includes a second portion having a second cross-sectional area, the second cross-sectional area being larger than the first cross-sectional area. The layer of non-adsorbent material is disposed either: i) in the first portion; or ii) in the second portion in a disposition directly adjacent to the first portion.

A fuel vapor canister for adsorbing fuel evaporated in a fuel tank of a vehicle is also provided. The fuel vapor canister includes a casing defining an internal volume therein. The casing includes a charge port for receiving fuel vapor from the fuel tank into the internal volume. The casing also includes a purge port for delivering fuel vapor from the internal volume to an engine of the vehicle. The charge port and the purge port are in fluid communication with the internal volume. The internal volume includes a chamber adjacent to the charge port and the purge port. A first layer of adsorbent material is disposed within the chamber. A layer of non-adsorbent material is disposed adjacent to the first layer of adsorbent material. The layer of non-adsorbent material is closer to the charge port and the purge port than the first layer of adsorbent material. The non-adsorbent material is one of: i) an open cell foam; ii) non-adsorbent particles; iii) air; and iv) any combination of i) through iii).

In specific embodiments, the open cell foam is formed of a polyurethane (PU) material or a polyether (PE) material.

In specific embodiments, the non-adsorbent particles have a Sauter mean diameter (SMD) of greater than 2 mm.

In specific embodiments, the adsorbent material is an activated carbon that is one of a granular carbon and a pellet carbon.

In specific embodiments, the chamber includes a first portion having a first cross-sectional area, the first portion being adjacent the inlet and outlet of the casing. The chamber further includes a second portion having a second cross-sectional area, the second cross-sectional area being larger than the first cross-sectional area. The chamber further includes a transition portion having a cross-sectional area that tapers between the first cross-sectional area of the first portion and the second cross-sectional area of the second portion. The layer of non-adsorbent material is disposed in either: i) the transition portion; or ii) the second portion in a disposition directly adjacent to the transition portion.

In specific embodiments, the layer of non-adsorbent material has a flow restriction that is less than a flow restriction of the first layer of adsorbent material.

A method of making an evaporative emissions canister is also provided. The method includes providing a casing defining an internal volume therein, the casing including an inlet and an outlet in fluid communication with the internal volume, and the internal volume including a chamber adjacent to the inlet and the outlet. The method further includes disposing a first layer of adsorbent material within the chamber. The method further includes disposing a layer of non-adsorbent material adjacent to the first layer of adsorbent material. The non-adsorbent material is one of: i) an open cell foam; ii) non-adsorbent particles; iii) air; and iv) any combination of i) through iii).

In specific embodiments, the layer of non-adsorbent material is disposed directly between the first layer of adsorbent material and one or both of the inlet and the outlet.

In specific embodiments, the method further includes the step of disposing a second layer of adsorbent material within the chamber. The layer of non-adsorbent material is sandwiched between the first layer of adsorbent material and the second layer of adsorbent material.

In specific embodiments, the open cell foam is formed of a polyurethane (PU) material or a polyether (PE) material.

In specific embodiments, the non-adsorbent particles have a Sauter mean diameter (SMD) of greater than 2 mm.

In specific embodiments, the adsorbent material is an activated carbon that is one of a granular carbon and a pellet carbon.

### DESCRIPTION OF THE DRAWINGS

Various advantages and aspects of this disclosure may be understood in view of the following detailed description when considered in connection with the accompanying drawings, wherein:

FIG. 1 is a side schematic cross-sectional view of the evaporative emissions canister in accordance with some embodiments of the disclosure;

FIG. 2 is a side schematic cross-sectional view of the evaporative emissions canister in accordance with other embodiments of the disclosure;

FIG. 3 is a side schematic cross-sectional view of the evaporative emissions canister in accordance with yet other embodiments of the disclosure;

FIG. 4 is a side schematic cross-sectional view of the evaporative emissions canister in accordance with yet other embodiments of the disclosure;

FIG. 5 is a cross-sectional view of an evaporative emissions canister in accordance with embodiments of the disclosure; and

FIG. 6 is another cross-sectional view of the evaporative emissions canister of FIG. 5.

### DETAILED DESCRIPTION OF THE INVENTION

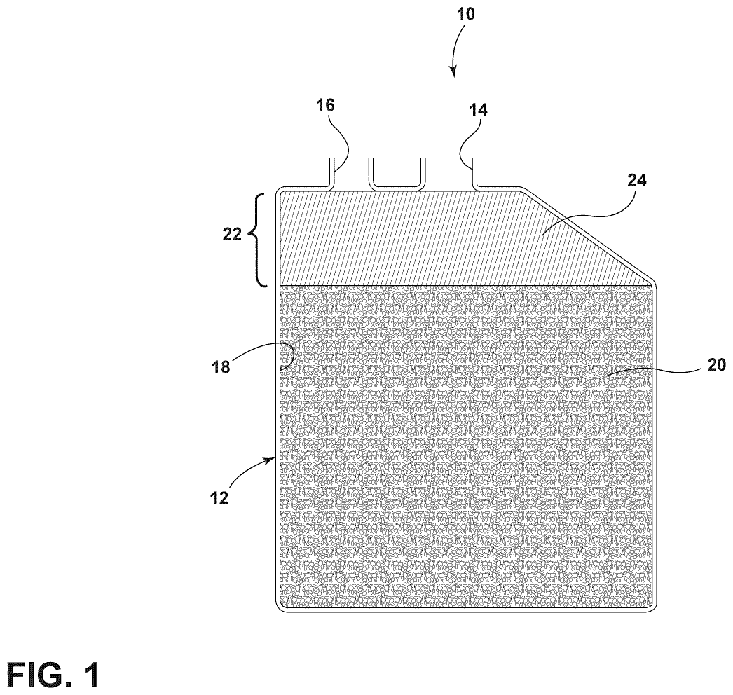

An evaporative emissions canister is provided. Referring to FIGS. 1-6, wherein like numerals indicate corresponding parts throughout the several views, the evaporative emissions canister is illustrated and generally designated as a fuel vapor canister 10 for a fuel tank of a vehicle fuel system that pumps liquid fuel, by way of non-limiting example gasoline fuel, from the fuel tank (not shown) to an internal combustion engine (not shown) that powers a vehicle such as an automotive vehicle. The fuel vapor canister 10 traps fuel vapors that arise in the fuel tank during periods of non-use of the internal combustion engine due to, for example, daily variations in ambient temperatures or a refueling event. The fuel vapor canister 10 exhibits improved, less restricted internal fluid flow without sacrificing the working capacity of the canister, thereby reducing the potential for bleed emissions and maintaining adsorption of fuel vapors from the fuel tank.

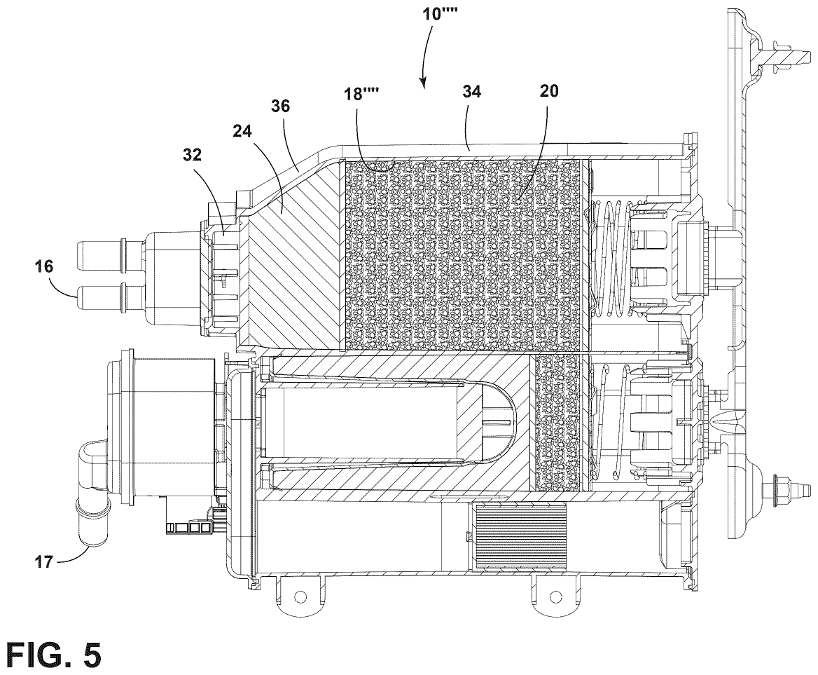

FIG. 1 generally depicts a fuel vapor canister 10 used in a vehicle fuel system. The fuel vapor canister 10 includes a casing 12 that forms a main body of the canister 10. The casing 12 defines an internal volume within the main body. The internal volume may include one single chamber inside the canister, or may be partitioned into a plurality of chambers. The casing 12 has at least one inlet and outlet in fluid communication with the internal volume of the casing 12. Particularly, the casing 12 has a charge port (tank port) 14 and a purge port 16, as well as a vent port (not shown). A vent port 17 is shown by way of example in FIG. 5. The charge port 14 and purge port 16 are disposed at one end of the internal volume of the casing 12 adjacent to one of the chambers 18 within the internal volume, while the vent port is disposed at an opposite end, so that there may be fluid flow between the charge port 14 and the vent port or between the vent port and the purge port 16. The charge port 14 is connected to and in fluid communication with the vehicle fuel tank via a conduit or similar. The charge port 14 is also in fluid communication with the chamber 18 within the internal volume of the casing 12. The purge port 16 is connected to and in fluid communication with an air intake system of the engine via a conduit or similar. The purge port 16 is also in fluid communication with the chamber 18 within the internal volume of the casing 12. The vent port (17) is open to the atmosphere for venting the canister 10 and for admission of purge air. The casing 12 is not limited to any particular geometry and may be box-shaped and have, for example, a generally rectangular cross-section in a direction generally perpendicular to the flow direction. However, the casing 12 may instead or in addition have or include separate chambers that have any one of a conical, a frustoconical, and/or a cylindrical shape and therefore a generally circular cross-section. During non-use of the internal combustion engine when the engine is off, fuel vapors generated in the fuel tank travel through the charge port 14 and into the internal volume of the casing 12. The fuel vapors become trapped in the canister casing 12, and air exits the casing 12 through the vent port (17). During periods of use of the internal combustion engine when the engine is running, air is drawn into the canister 10 through the vent port, and the trapped fuel vapors are expelled from the casing 12 through the purge port 16 and into the air intake system of the internal combustion engine. It is therefore apparent that the charge port 14 is an inlet and the purge port 16 is an outlet, while the vent port may be an outlet or an inlet depending on the operation of the canister 10 (charging versus purging) and the associated direction of flow. A fluid flow path thereby extends from the charge port 14 through the internal volume of the casing 12 to the vent port in one direction of flow in one operational mode of the canister 10, and from the vent port through the internal volume of the casing 12 to the purge port 16 in another operational mode of the canister 10.

In some embodiments as shown in FIG. 1, the chamber 18 of the canister 10 includes a bed of adsorbent material 20 in the form of a layer of adsorbent material. The adsorbent material 20 is not particularly limited and may be an activated carbon such as a powdered carbon, a granular carbon, a pellet carbon, extruded carbon, spherical carbon, or carbon sheets. However, it should be understood that the adsorbent material may be other types or forms of adsorbent material such as spherical, honeycomb, cylindrical, cross-hedge, sheets, or structured media of an extruded, wound, folded, pleated, corrugated, bonded, or poured form. Further, the adsorbent material 20 may have a Sauter mean diameter (SMD) of less than approximately 2 mm. In specific embodiments, the adsorbent material 20 is an activated granular carbon having a Sauter mean diameter particle size under 2 mm. In other specific embodiments, the adsorbent material 20 is an activated pellet carbon. In yet other embodiments, the adsorbent material 20 may be another form of activated carbon. The chamber 18 further includes a non-adsorbent zone 22 that is disposed directly between the bed of adsorbent material 20 and both the charge port 14 and the purge port 16, which are an inlet and outlet, respectively. The non-adsorbent zone 22 is therefore closer to the charge port 14 and purge port 16 than the bed of adsorbent material 20. The non-adsorbent zone 22 may have a height of at least approximately 10 mm, although it should be understood that the height of the non-adsorbent zone may also depend on the cross-sectional dimensions of the canister in planes that are perpendicular to the height direction. Further, the cross-sectional area of the chamber 18 may not be constant and instead may increase as a distance from the charge port 14 and/or purge port 16 into the chamber 18 increases. Thus, the chamber 18 may have a smaller cross-sectional area at the charge port 14 and purge port 16, and a larger cross-sectional area at a distance spaced from the charge port and outlet. The non-adsorbent zone 22 may be located in a transitional zone in which the cross-sectional area changes from the small cross-sectional area to the larger cross-sectional area. Further, the non-adsorbent zone 22 has a flow restriction (resistance to fluid flow) that is less than a flow restriction of the bed of adsorbent material 20.

In specific embodiments, the non-adsorbent zone 22 of the canister 10 is filled with and constituted by a bed of non-adsorbent material 24 in the form of a layer of non-adsorbent particles. For example, the non-adsorbent particles constituting the non-adsorbent material 24 may be particles having a Sauter mean diameter (SMD) of greater than 2 mm. Further, the non-adsorbent material 24 is typically a non-activated material but in optionally may be an activated material. The non-adsorbent material generally does not adsorb fuel vapors that enter into and travel within the canister 10, and any adsorption of fuel vapors by the non-adsorbent material is negligible.

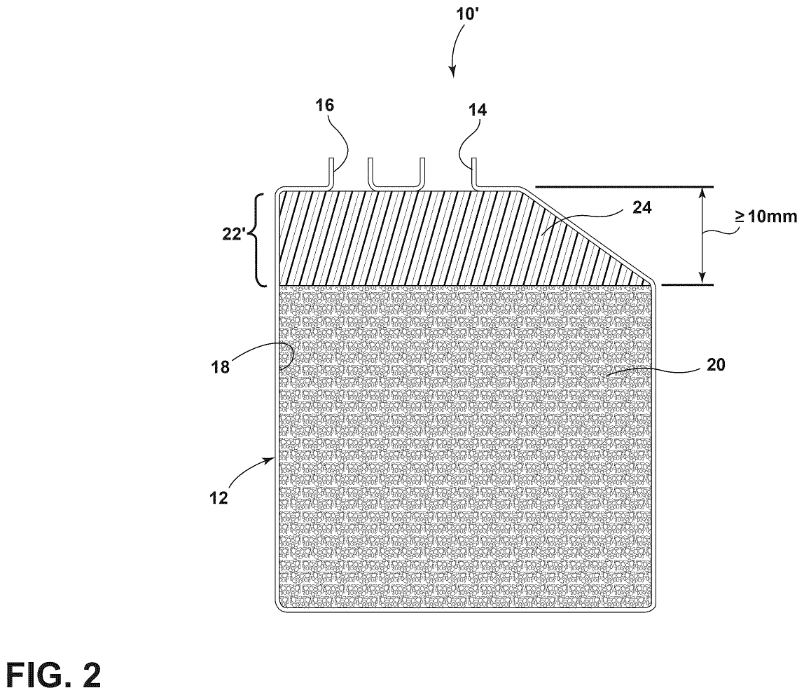

In other embodiments such as shown in FIG. 2 the non-adsorbent zone 22′ of the canister 10′ is filled with and constituted by a layer of open cell foam material 26. The open cell foam 26 may be, for example, formed of a polyurethane (PU) material or a polyether (PE) material, and as such may be a synthetic foam. Alternatively, the open cell foam may be a natural foam. The open cell foam is non-adsorbent and as such generally does not absorb fuel vapors that enter into and travel within the canister 10′. The open cell foam is highly porous and generally has a cell size, pore size, surface area, ligament thickness, and shape that results in a flow restriction that is less than the flow restriction of the layer of adsorbent material 20. Consistent with the height of the non-adsorbent zone 22′, the open cell foam 26 may have a thickness of greater than or equal to 10 mm.

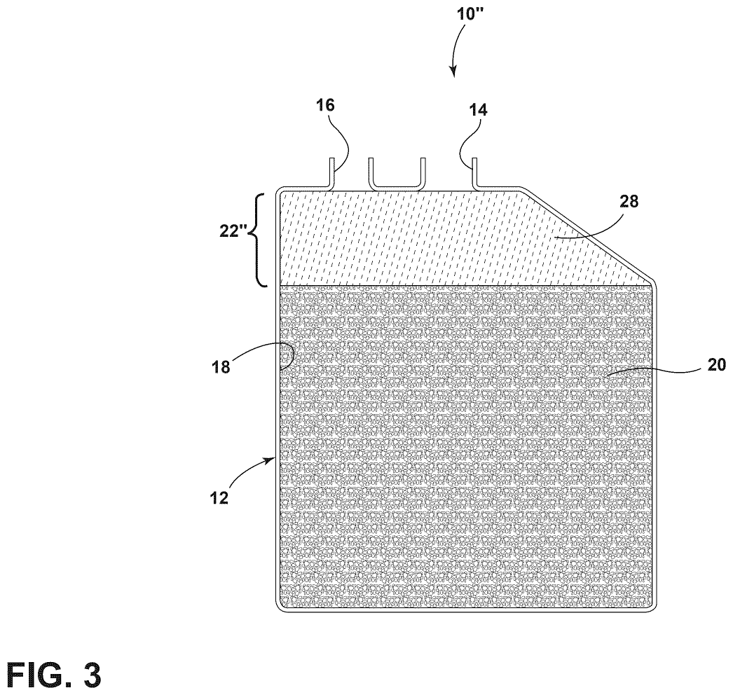

In yet other embodiments such as shown in FIG. 3, the non-adsorbent zone 22″ of the canister 10″ is a void space 28 that does not include particles or other material such as foams and is instead filled with air or other inert and/or non-adsorbent gas. The void space 28 extends throughout the non-adsorbent zone 22″ between the charge port 14 and purge port 16 on one side and the adsorbent material 20 on the other. The void space 28 generally has a flow restriction that is less than the flow restriction of the layer of adsorbent material 20. Consistent with the height of the non-adsorbent zone 22″, the void space 28 may have a height of greater than or equal to 10 mm. In these embodiments, although the void space 28 does not include non-adsorbent particles or non-adsorbent foam material, the void space 28 may be maintained by non-adsorbent materials such as spaces, springs, and the like.

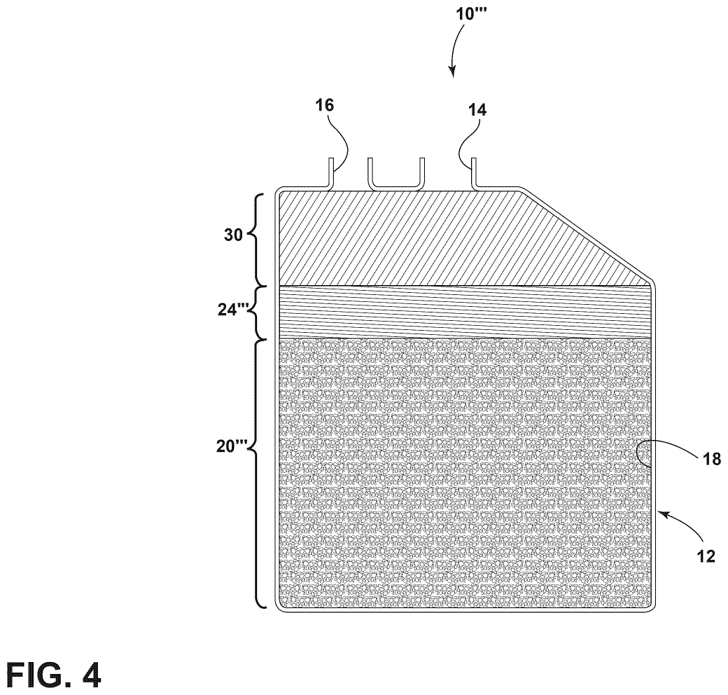

In yet other embodiments such as shown in FIG. 4, the chamber 18 of the canister 10′″ includes a bed of adsorbent material 20′″ in the form of a first layer of adsorbent material. The first layer of adsorbent material 20′″ is not particularly limited and may be an activated carbon such as a granular carbon or a pellet carbon. In particular embodiments, the first layer of adsorbent material 20′″ is a granular carbon having a high flow restriction. For example, the granular carbon may have a Sauter mean diameter of less than approximately 2 mm. A layer of non-adsorbent material 24′″ is disposed adjacent to the first layer of adsorbent material 20′″. The layer of non-adsorbent material 24′″ is closer to the charge port (inlet) 14 and the purge port (outlet) 16 than the first layer of adsorbent material 20′″. The layer of non-adsorbent material 24′″ is outside of the transition zone of changing cross-sectional area. The layer of non-adsorbent material 24′″ may also be adjacent to the transition zone such that the layer of non-adsorbent material neighbors and abuts or nearly abuts against the transition zone. As in the embodiments above, the non-adsorbent material 24′″ may be any one of non-adsorbent particles (such as those have a Sauter mean diameter of greater than 2 mm), an open cell foam, or air (filling a void space). The non-adsorbent material 24′″ has a low flow restriction, and particularly a flow restriction less than the first layer of adsorbent material 20′″. The chamber 18 further includes a bed of adsorbent material 30 in the form of a second layer of adsorbent material. The layer of non-adsorbent material 24′″ is sandwiched between the first layer of adsorbent material 20′″ and the second layer of adsorbent material 30. The second layer of adsorbent material 30 is not particularly limited and may be an activated carbon such as a granular carbon or a pellet carbon. In particular embodiments, the second layer of adsorbent material 30 is a pellet carbon having a low flow restriction, while the first layer of adsorbent material 20′″ is a granular carbon having a high flow restriction. For example, the second layer of adsorbent material 30 may have a larger Sauter mean particle diameter than the first layer of adsorbent material 20′″. The second layer of adsorbent material 30 thus may have a flow restriction that is less than a flow restriction of the first layer of adsorbent material 20′″, and the layer of non-adsorbent material 24′″ may also have a flow restriction that is lower than the flow restriction of the first layer of adsorbent material 20′″. Additionally, in particular embodiments, the second layer of adsorbent material 30 is located in the transition zone of changing cross-sectional area, and the second layer of adsorbent material 30 is closer to the charge port 14 and purge port 16 than the first layer of adsorbent material 20′″. Further, the layer of non-adsorbent material 24′″ is located directly adjacent to the transition zone that has a smaller cross-sectional area than the cross-sectional area of the chamber 18 in the location of the first layer of adsorbent material 20′″. It should be understood that the terms “first” and “second” with respect to the layers of adsorbent materials are used merely to distinguish the layers and are not ordinal and do not imply anything related to the layers position in series, such as their order in relation to the direction of flow or relative distance from the ports.

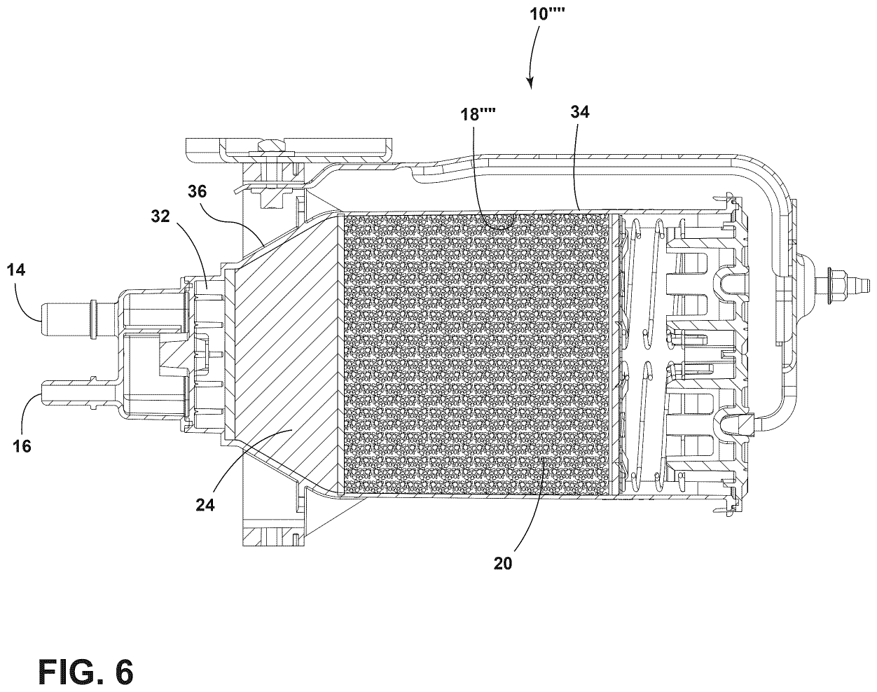

In yet other embodiments such as shown in FIGS. 5 and 6, the chamber 18″″ of the canister 10″″ includes a first portion 32 having a first cross-sectional area. The first portion 32 is adjacent to the charge port 14 and the purge port 16. The chamber 18″″ also includes a second portion 34 having a second cross-sectional area that is larger than the first cross-sectional area of the first portion 32. The chamber 18″″ further includes a transition portion 36 that has a cross-sectional area that tapers between the first cross-sectional area of the first potion 32 and the second cross-sectional area of the second portion 34. The transition portion 36 may be referred to as a “bottleneck” region within the chamber 18″″. Due to the geometry of the bottleneck region, when the chamber 18″″ is empty, the transition portion 36 has a higher restriction to flow than the second portion 34. The layer of non-adsorbent material may be disposed in either the transition portion 36 of the chamber 18″″, or the second portion 34 in a disposition directly adjacent to the transition portion 36. As shown in FIGS. 5 and 6, the non-adsorbent material 24 is disposed in the transition portion 36. The non-adsorbent material is selected from any of the non-adsorbent materials described above and has the same properties thereof. The layer of adsorbent material 20 is disposed in the second portion 34. The adsorbent material is selected from any of the adsorbent materials described above and has the same properties thereof. The cross-section of the second portion 34 may be made wider to reduce flow restriction, and the adsorbent material 20 is thereby added to a wider cross-section to maintain the adsorbing capacity of the canister 10 despite the presence of a non-adsorbent zone in the transition portion 36 filled with the non-adsorbent material 24. Thus, the adsorbent material is filled in the portion of the canister chamber that has the widest cross-sectional area to maintain the working capacity of the canister while combating against flow restriction limitations caused by the geometry of the canister chamber 18. A layer of adsorbent material may also be disposed in the first portion 32, or the first portion 32 may include empty void space. In the case that the first portion includes a layer of adsorbent material, the layer of adsorbent material in the first portion 32 may have a flow restriction less than the layer of adsorbent material in the second portion 34.

With reference again to FIG. 1, a method of making the evaporative emissions canister 10 includes disposing the first layer of adsorbent material 20 withing the chamber 18 defined at least in part by the internal volume of the casing 12. The first layer of adsorbent material 20 may contact and be adjacent to a partition such as a screen or similar at an end of the chamber 18 distal from the charge port 14 and purge port 16. The partition separates the chamber 18 from other chamber(s) and/or other portions of the internal volume of the casing 12. The method further includes disposing the layer of non-adsorbent material 24 in a non-adsorbent zone 22 adjacent to the first layer of adsorbent material 20. The non-adsorbent material may be any one of or combination of an open cell foam, non-adsorbent particles, and air as described above. The layer of non-adsorbent material 24 may be disposed directly between the first layer of adsorbent material 20 and one or both of the charge port 14 and the purge port 16. Optionally, the method may further and subsequently include disposing a second layer of adsorbent material 30 within the chamber 18 as shown in FIG. 4. The layer of non-adsorbent material 24 is thus sandwiched between the first layer of adsorbent material 20 and the second layer of adsorbent material 30. If, for example, the non-adsorbent material 24 is air filling a void space, one or both of the first layer of adsorbent material 20 and the second layer of adsorbent material 30 may be separated from the void space by partition(s) such as screen(s) or similar. It should also be understood that in any of the embodiments, even those not including a second layer of adsorbent material, the layer of adsorbent material and the layer of non-adsorbent material may be separated by such a partition.

With reference again to FIG. 1, during periods of non-operation of a vehicle's internal combustion engine, fuel vapors generated from the liquid fuel stored in the fuel tank enter the fuel vapor storage canister 10 through the charge port 14. As the fuel vapors pass into the layer of adsorbent material 20 within the casing 12, the fuel vapors are adsorbed by the adsorbent material 20. Essentially only clean air exits the canister 10 through the vent port while the fuel vapors remain trapped within the canister 10. When the internal combustion engine is started and operational, external air is drawn into the canister 10 through the vent port. As the air passes through the layer of adsorbent material 20, the fuel vapors are desorbed into the air and carried away from the adsorbent material 20 and into the flow of air. The flow of charge air is thus generally in the direction from the charge port 14 to the vent port, with the charge port 14 being on an upstream side and the vent port 18 being on a downstream side. The layer of non-adsorbent material 24 provides a less flow-restrictive canister 10, for example by being disposed in flow-restricted zones of the canister volume such as in or adjacent to zones of changing cross-sectional area. Hence, during charging that is accomplished during non-operation of the vehicle engine, the adsorbent material 20 in the canister 10 is more completely charged with fuel vapors for later purging into the intake air of the engine when the engine is next turned on. By improving the flow through the canister 10 and by maintaining the same working capacity as canisters without a non-adsorbent zone, the non-adsorbent material 24 can provide more homogeneous flow through the canister 10 and reduce bleed emissions of fuel hydrocarbons to the atmosphere.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements by ordinal terms, for example “first,” “second,” and “third,” are used for clarity, and are not to be construed as limiting the order in which the claim elements appear. Any reference to claim elements in the singular, for example, using the articles “a,” “an,” “the” or “said,” is not to be construed as limiting the element to the singular.

What is claimed is:

1. An evaporative emissions canister comprising:
a casing defining an internal volume therein;
the casing including an inlet and an outlet in fluid communication with the internal volume;
the internal volume including a chamber adjacent to the inlet and the outlet;
a bed of adsorbent material within the chamber; and
a non-adsorbent zone within the chamber, the non-adsorbent zone being disposed directly between the layer of adsorbent material and one or both of the inlet and the outlet;
wherein the non-adsorbent zone is one of: i) an open cell foam; ii) a bed of non-adsorbent material; iii) a void space; and iv) any combination of i) through iii).

2. The evaporative emissions canister of claim 1, wherein the non-adsorbent zone has a height of at least 10 mm.

3. The evaporative emissions canister of claim 1, wherein the open cell foam is formed of a polyurethane (PU) material or a polyether (PE) material.

4. The evaporative emissions canister of claim 3, wherein the open cell foam has a thickness of at least 10 mm.

5. The evaporative emissions canister of claim 1, wherein the non-adsorbent material has a Sauter mean diameter (SMD) of greater than 2 mm.

6. The evaporative emissions canister of claim 1, wherein the void space is filled with air.

7. The evaporative emissions canister of claim 1, wherein the adsorbent material has a Sauter mean diameter (SMD) of less than 2 mm.

8. The evaporative emissions canister of claim 1, wherein the adsorbent material is an activated carbon that is one of a granular carbon and a pellet carbon.

9. The evaporative emissions canister of claim 1, wherein the non-adsorbent zone has a flow restriction that is less than a flow restriction of the bed of adsorbent material.

10. An evaporative emissions canister comprising:
a casing defining an internal volume therein;
the casing including an inlet and an outlet in fluid communication with the internal volume;
the internal volume including a chamber adjacent to the inlet and the outlet;
a first layer of adsorbent material within the chamber; and
a layer of non-adsorbent material adjacent to the first layer of adsorbent material;
wherein the non-adsorbent material is one of: i) an open cell foam; ii) non-adsorbent particles; iii) air; and iv) any combination of i) through iii).

11. The evaporative emissions canister of claim 10, wherein the open cell foam is formed of a polyurethane (PU) material or a polyether (PE) material.

12. The evaporative emissions canister of claim 10, wherein the non-adsorbent particles have a Sauter mean diameter (SMD) of greater than 2 mm.

13. The evaporative emissions canister of claim 10, wherein the adsorbent material is an activated carbon that is one of a granular carbon and a pellet carbon.

14. The evaporative emissions canister of claim 10, wherein the layer of non-adsorbent material is disposed directly between the first layer of adsorbent material and one or both of the inlet and the outlet.

15. The evaporative emissions canister of claim 10, wherein the layer of non-adsorbent material has a flow restriction that is less than a flow restriction of the first layer of adsorbent material.

16. The evaporative emissions canister of claim 10, further including a second layer of adsorbent material within the chamber;
wherein the layer of non-adsorbent material is sandwiched between the first layer of adsorbent material and the second layer of adsorbent material.

17. The evaporative emissions canister of claim 16, wherein the second layer of adsorbent material has a flow restriction that is less than a flow restriction of the first layer of adsorbent material, and the layer of non-adsorbent material has a flow restriction that is lower than the flow restriction of the first layer of adsorbent material.

18. The evaporative emissions canister of claim 17, wherein the second layer of adsorbent material is closer to the inlet and outlet than the first layer of adsorbent material.

19. The evaporative emissions canister of claim 16, wherein the adsorbent material forming the first layer is an activated carbon that is one of a granular carbon and a pellet carbon, and the adsorbent material forming the second layer is one of a granular carbon and a pellet carbon.

20. The evaporative emissions canister of claim 10, wherein:
the chamber includes a first portion having a first cross-sectional area, the first portion being adjacent the inlet and outlet of the casing;
the chamber further includes a second portion having a second cross-sectional area, the second cross-sectional area being larger than the first cross-sectional area; and
the layer of non-adsorbent material is disposed either: i) in the first portion; or ii) in the second portion in a disposition directly adjacent to the first portion.

21. A fuel vapor canister for adsorbing fuel evaporated in a fuel tank of a vehicle, the fuel vapor canister comprising:
a casing defining an internal volume therein;
the casing including a charge port for receiving fuel vapor from the fuel tank into the internal volume;
the casing including a purge port for delivering fuel vapor from the internal volume to an engine of the vehicle;
the charge port and the purge port being in fluid communication with the internal volume;
the internal volume including a chamber adjacent to the charge port and the purge port;
a first layer of adsorbent material within the chamber; and
a layer of non-adsorbent material adjacent to the first layer of adsorbent material, the layer of non-adsorbent material being closer to the charge port and the purge port than the first layer of adsorbent material;
wherein the non-adsorbent material is one of: i) an open cell foam; ii) non-adsorbent particles; iii) air; and iv) any combination of i) through iii).

22. The fuel vapor canister of claim 21, wherein the open cell foam is formed of a polyurethane (PU) material or a polyether (PE) material.

23. The fuel vapor canister of claim 21, wherein the non-adsorbent particles have a Sauter mean diameter (SMD) of greater than 2 mm.

24. The fuel vapor canister of claim 21, wherein the adsorbent material is an activated carbon that is one of a granular carbon and a pellet carbon.

25. The fuel vapor canister of claim 21, wherein:
the chamber includes a first portion having a first cross-sectional area, the first portion being adjacent the inlet and outlet of the casing;
the chamber further includes a second portion having a second cross-sectional area, the second cross-sectional area being larger than the first cross-sectional area;
the chamber further includes a transition portion having a cross-sectional area that tapers between the first cross-sectional area of the first portion and the second cross-sectional area of the second portion; and
the layer of non-adsorbent material is disposed in either: i) the transition portion; or ii) the second portion in a disposition directly adjacent to the transition portion.

26. The fuel vapor canister of claim 25, wherein the layer of non-adsorbent material has a flow restriction that is less than a flow restriction of the first layer of adsorbent material.

27. A method of making an evaporative emissions canister, the method comprising the steps of:
providing a casing defining an internal volume therein, the casing including an inlet and an outlet in fluid communication with the internal volume, the internal volume including a chamber adjacent to the inlet and the outlet;
disposing a first layer of adsorbent material within the chamber; and
disposing a layer of non-adsorbent material adjacent to the first layer of adsorbent material;
wherein the non-adsorbent material is one of: i) an open cell foam; ii) non-adsorbent particles; iii) air; and iv) any combination of i) through iii).

28. The method of claim 27, wherein the layer of non-adsorbent material is disposed directly between the first layer of adsorbent material and one or both of the inlet and the outlet.

29. The method of claim 27, further including the step of disposing a second layer of adsorbent material within the chamber;
wherein the layer of non-adsorbent material is sandwiched between the first layer of adsorbent material and the second layer of adsorbent material.

30. The method of claim 27, wherein the open cell foam is formed of a polyurethane (PU) material or a polyether (PE) material.

31. The method of claim 27, wherein the non-adsorbent particles have a Sauter mean diameter (SMD) of greater than 2 mm.

32. The method of claim 27, wherein the adsorbent material is an activated carbon that is one of a granular carbon and a pellet carbon.
